(19) United States
(12) Patent Application Publication
(10) Pub. No.: US 2011/0187444 A1
(43) Pub. Date: Aug. 4, 2011

(54) VOLTAGE TRIMMING CIRCUIT OF SEMICONDUCTOR MEMORY APPARATUS

(75) Inventors: Sin Hyun JIN, Ichon-shi (KR); Jong Chern Lee, Ichon-shi (KR)

(73) Assignee: Hynix Semiconductor Inc., Ichon-shi (KR)

(21) Appl. No.: 12/839,287

(22) Filed: Jul. 19, 2010

(30) Foreign Application Priority Data
Jan. 29, 2010 (KR) 10-2010-0008691

(51) Int. Cl. G05F 3/02

(52) U.S. Cl. 327/538

(57) ABSTRACT

A voltage trimming circuit of a semiconductor memory apparatus may include a first voltage generation block configured to select voltage levels of a first node and a second node and divide a voltage between the first node and the second node to generate a first division voltage group; a second voltage generation block configured to select voltage levels of a third node and a fourth node and divide a voltage between the third node and the fourth node to generate a second division voltage group; a first switch block configured to select one division voltage of the first division voltage group to output the selected division voltage as a first reference voltage; and a second switch block configured to select one division voltage of the second division voltage group to output the selected division voltage as a second reference voltage.

### CROSS-REFERENCES TO RELATED APPLICATION

The present application claims priority under 35 U.S.C. §119(a) to Korean Application No. 10-2010-0008691, filed on Jan. 29, 2010, in the Korean Intellectual Property Office, which is incorporated herein by reference in its entirety as set forth in full.

### BACKGROUND

1. Technical Field

The present invention relates to semiconductor integrated circuits, and more particularly, to a voltage trimming circuit of a semiconductor memory apparatus.

2. Related Art

A semiconductor memory apparatus may be configured to a large number of internal circuits. Voltage levels required by each one of the internal circuits may be different. A voltage trimming circuit may adjust voltage levels to supply different voltage levels required by the different internal circuits or exact voltage levels need to be generated.

FIG. 1 is a diagram illustrating a voltage trimming circuit used in a conventional semiconductor memory apparatus. The voltage trimming circuit includes a voltage division block 10, a first switch block 20, a second switch block, 30, and a third switch block 40.

The voltage division block 10 may include a plurality of resistors, including Main R1, Main R2, and R0 through R30 which are connected in series. A supply voltage V_supply may be applied to one terminal of the voltage division block 10 and a ground terminal VSS may be connected to the other terminal of the voltage division block 10. In addition, the voltage division block 10 may generate first through thirty-second division voltages V_d<0> through V_d<31> at respective nodes to which the resistors Main R1, Main R2, and R0 through R30 are connected.

The first switch block 20 may select one of the first through twenty-fourth division voltages V_d<0> through V_d<23> and output the selected division voltage as a first reference voltage Vref1.

The second switch block 30 may select one of the fifth through twenty-eighth division voltages V_d<4> through V_d<27> and output the selected division voltage as a second reference voltage Vref2.

The third switch block 40 may select one of the ninth through thirty-second division voltages V_d<8> through V_d<31> and output the selected division voltage as a third reference voltage Vref3.

The first through third switch blocks 20 through 40 may have the substantially same internal configurations, except for the input division voltages and the output reference voltages. Thus, only the first switch block 20 will be described below. The description of first switch block 20 may apply to the second switch block 30 and the third switch block 40.

As illustrated in FIG. 2, the first switch block 20 may include first through twenty-fourth switches SW<0> through SW<23>. The first through twenty-fourth division voltages V_d<0> through V_d<23> may be inputted to input terminals of switches SW<0> through SW<23>, respectively. Output terminals of the respective switches SW<0> through SW<23> are commonly connected. The first reference voltage Vref1 may be outputted through a node where the output terminals of the respective switches SW<0> through SW<23> are commonly connected.

The voltage trimming circuit used in the conventional semiconductor memory apparatus described above may select the first through third reference voltages Vref1 through Vref3 in different voltage level ranges. For example, the first reference voltage Vref1 may be a voltage ranging from 0.1 V to 2.4 V, the second reference voltage Vref2 may be a voltage ranging from 0.5 V to 2.8 V, and the third reference voltage Vref3 may be a voltage ranging from 0.9 V to 3.2 V.

The voltage trimming circuit may generate three reference voltages having different levels. In order to generate the three reference voltages, the conventional voltage trimming circuit of FIGS. 1 and 2 may select one of the twenty-four division voltages as each reference voltage. The voltage trimming circuit may include seventy-two lines from the voltage division block 10 to the respective switch bocks 20 through 40, and twenty-four switches in each switch block 20 through 40 for a total of seventy-two switches.

As such, the conventional voltage trimming circuit includes a large number of lines and switches. The large number of lines and switches may serve as a factor for degrading the area efficiency of the semiconductor memory apparatus.

### SUMMARY

In one embodiment of the present invention, a voltage trimming circuit of a semiconductor memory apparatus comprises a first voltage generation block configured to select voltage levels of a first node and a second node and divide a voltage between the first node and the second node to generate a first division voltage group; a second voltage generation block configured to select voltage levels of a third node and a fourth node and divide a voltage between the third node and the fourth node to generate a second division voltage group; a first switch block configured to select one division voltage of the first division voltage group to output the selected division voltage as a first reference voltage; and a second switch block configured to select one division voltage of the second division voltage group to output the selected division voltage as a second reference voltage. Here, the voltage levels of the third node and the fourth node may be different from the voltage levels of the first node and the second node respectively.

In another embodiment of the present invention, a voltage trimming circuit of a semiconductor memory apparatus comprises a first voltage generation block configured to divide a supply voltage, generate a first division voltage group, and select a maximum voltage level and a minimum voltage level of the first division voltage group; a second voltage generation block configured to divide the supply voltage, generate a second division voltage group, and select a maximum voltage level and a minimum voltage level of the second division voltage group; a first switch block configured to select one division voltage of the first division voltage group to output the selected division voltage as a first reference voltage; and a second switch block configured to select one division voltage of the second division voltage group to output the selected division voltage as a second reference voltage.

### BRIEF DESCRIPTION OF THE DRAWINGS

Features, aspects, and embodiments are described in conjunction with the attached drawings, in which:

FIG. 1 is a diagram illustrating a voltage trimming circuit of a conventional semiconductor memory apparatus;

FIG. 2 is a configuration diagram of a first switch block shown in FIG. 1;

FIG. 3 is a schematic block diagram of a voltage trimming circuit of a semiconductor memory apparatus according to one embodiment;

FIG. 4 is a configuration diagram of a first voltage generation block of FIG. 3; and

FIG. 5 is a configuration diagram of a first switch block of FIG. 3.

### DETAILED DESCRIPTION

Reference will now be made in detail to the exemplary embodiments consistent with the present disclosure, examples of which are illustrated in the accompanying drawings. Whenever possible, the same reference numerals will be used throughout the drawings to refer to the same or like parts.

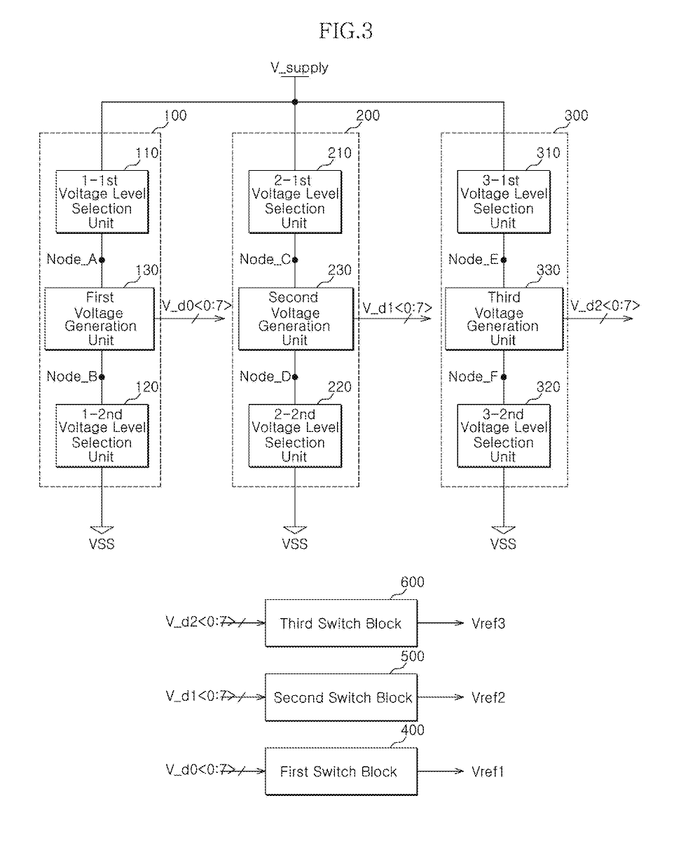

FIG. 3 is a diagram illustrating a voltage trimming circuit of a semiconductor memory apparatus according to one embodiment. The voltage trimming circuit may include first through third voltage generation blocks 100 through 300, and first through third switch blocks 400 through 600.

The first voltage generation block 100 may be configured to divide a supply voltage V_supply, generate a first division voltage group V_d0<0:7>, and select a maximum voltage level and a minimum voltage level of the first division voltage group V_d0<0:7>, For example, the first voltage generation block 100 may select and determine voltage levels of a first node Node_A and a second node Node_B, divide a voltage between the first node Node_A and the second node Node_B, and generate the first division voltage group V_d0<0:7>.

The first voltage generation block 100 may include a 1-1st voltage level selection unit 110, a 1-2nd voltage level selection unit 120, and a first division voltage generation unit 130, which are connected in series between a voltage supply node V_supply and a ground voltage node VSS. Here, a node to which the supply voltage V_supply is applied is referred to as the voltage supply node V_supply, and an identical reference symbol is assigned thereto.

The 1-1st voltage level selection unit 110 may be configured to select the voltage level of the first node Node_A.

The 1-2nd voltage level selection unit 120 may be configured to select the voltage level of the second node Node_B.

The first division voltage generation unit 130 may be configured to divide the voltages of the first and second nodes Node_A and Node_B and generate the first division voltage group V_d0<0:7>.

The second voltage generation block 200 may be configured to divide the supply voltage V_supply, generate a second division voltage group V_d1<0:7>, and select a maximum voltage level and a minimum voltage level of the second division voltage group V_d1<0:7>. For example, the second voltage generation block 200 may select and determine voltage levels of a third node Node_C and a fourth node Node_D, divide a voltage between the third node Node_C and the fourth node Node_D, and generate the second division voltage group V_d1<0:7>.

The second voltage generation block 200 may include a 2-1st voltage level selection unit 210, a 2-2nd voltage level selection unit 220, and a second division voltage generation unit 230, which are connected in series between the voltage supply node V_supply and the ground voltage node VSS.

The 2-1st voltage level selection unit 210 may be configured to select the voltage level of the third node Node_C.

The 2-2nd voltage level selection unit 220 may be configured to select the voltage level of the fourth node Node_D.

The second division voltage generation unit 230 may be configured to divide the voltages of the third and fourth nodes Node_C and Node_D and generate the second division voltage group V_d1<0:7>.

The third voltage generation block 300 may be configured to divide the supply voltage V_supply, generate a third division voltage group V_d2<0:7>, and select a maximum voltage level and a minimum voltage level of the third division voltage group V_d2<0:7>. For example, the third voltage generation block 300 may select and determine voltage levels of a fifth node Node_E and a sixth node Node_F, divide a voltage between the fifth node Node_E and the sixth node Node_F, and generate the third division voltage group V_d2<0:7>.

The third voltage generation block 300 may include a 3-1st voltage level selection unit 310, a 3-2nd voltage level selection unit 320, and a third division voltage generation unit 330, which are connected in series between the voltage supply node V_supply and the ground voltage node VSS.

The 3-1st voltage level selection unit 310 may be configured to select the voltage level of the fifth node Node_E.

The 3-2nd voltage level selection unit 320 may be configured to select the voltage level of the sixth node Node_F.

The third division voltage generation unit 330 may be configured to divide the voltages of the fifth and sixth nodes Node_E and Node_F and generate the third division voltage group V_d2<0:7>. At this time, the respective division voltages V_d0<i> of the first division voltage group V_d0<0:7> may have different voltage levels. The respective division voltages V_d1<j> of the second division voltage group V_d1<0:7> may have different voltage levels. The respective division voltages V_d2<k> of the third division voltage group V_d2<0:7> may have different voltage levels. In addition, the voltage levels of the first and second nodes Node_A and Node_B, the third and fourth nodes Node_C and Node_D, and the fifth and sixth nodes Node_E and Node_F may be different from one another.

The first switch block 400 may be configured to select one division voltage V_d0<i> of the first division voltage group V_d0<0:7> and output the selected division voltage V_d0<i> as the first reference voltage Vref1.

The second switch block 500 may be configured to select one division voltage V_d1<j> of the second division voltage group V_d1<0:7> and output the selected division voltage V_d1<j> as the second reference voltage Vref2.

The third switch block 600 may be configured to select one division voltage V_d2<k> of the third division voltage group V_d2<0:7> and output the selected division voltage V_d2<k> as the third reference voltage Vref3.

The first through third voltage generation blocks 100 through 300 may have the substantially same internal configuration, except for the outputted division voltage groups. Thus, the description of the first division voltage generation block 100 below may apply equally to the second and third voltage generation blocks 200 and 300.

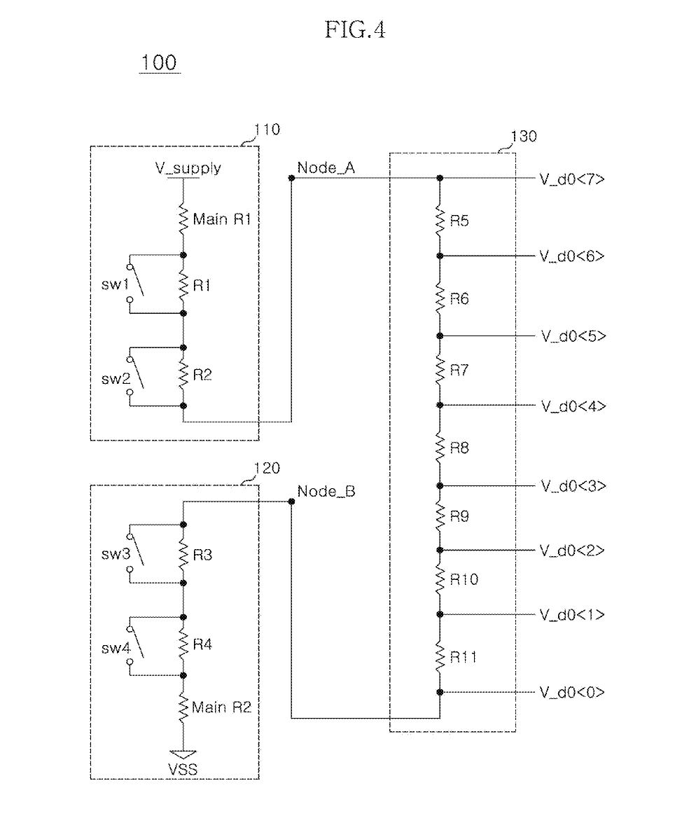

As illustrated in FIG. 4, the first voltage generation block 100 may include a 1-1st voltage level selection unit 110 connected between the voltage supply node V_supply and the first node Node_A, a 1-2nd voltage level selection unit 120 connected between the ground voltage node VSS and the second node Node_B, and a first division voltage generation unit 130 connected between the first node Node_A and the second node Node_B.

The 1-1st voltage level selection unit 110 may include first through third resistors Main R1, R1, and R2 and first and second switches SW1 and SW2. The first through third resistors Main R1, R1, and R2 may be connected in series between the voltage supply node V_supply and the first node Node_A. The first switch SW1 may be connected to both terminals of the second resistor R1. The second switch SW2 may be connected to both terminals of the third resistor R2.

The 1-2nd voltage level selection unit 120 may include fourth through sixth resistors R3, R4, and Main R2 and third and fourth switches SW3 and SW4. The fourth through sixth resistors R3, R4, and Main R2 may be connected in series between the second node Node_B and the ground voltage node VSS. The third switch SW3 may be connected to both terminals of the fourth resistor R3. The fourth switch SW4 may be connected to both terminals of the fifth resistor R4.

The first division voltage generation unit 130 may include seventh through thirteenth resistors R5 through R11. The seventh through thirteenth resistors R5 through R11 are connected in series between the first node Node_A and the second node Node_B. At this time, the first division voltage group V_d0<0:7> may be outputted through terminals of the seventh through thirteenth resistors R5 through R11.

The first through third switch blocks 400 through 600 may have the substantially same internal configuration, except for the inputted division voltage groups and the outputted reference voltages. Thus, the description of the first switch block 400 described below may apply equally applied to switch blocks 500 and 600.

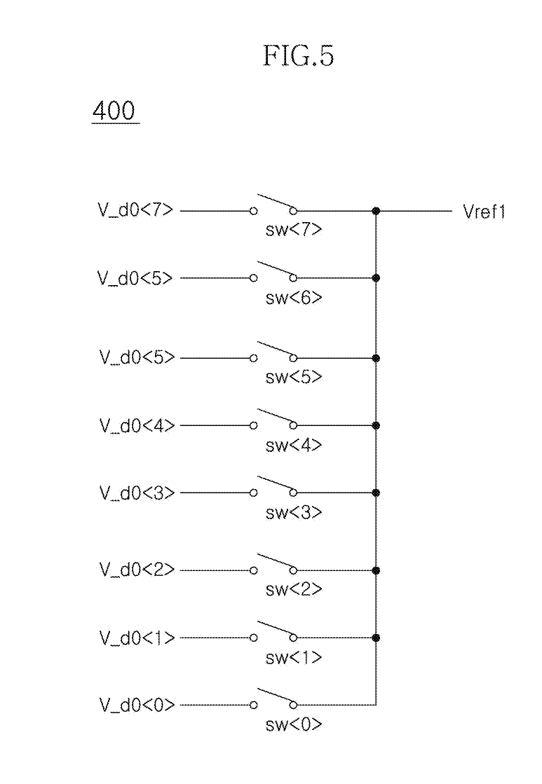

As illustrated in FIG. 5, first switch block 400 may include fifth through twelfth switches SW<0> through SW<7>. The respective division voltages V_d0<0>, V_d0<1>, V_d0<2>, V_d0<3>, V_d0<4>, V_d0<5>, V_d0<6> and V_d0<7> of the first division voltage group V_d0<0:7> may be inputted to the input terminals of the respective switches SW<0> through SW<7>. The output terminals of the respective switches SW<0> through SW<7> may be commonly connected. The first reference voltage Vref1 may be outputted through a node to which the output terminals of the respective switches SW<0> through SW<7> are commonly connected.

The operation of the voltage trimming circuit of the semiconductor memory apparatus configured as above, according to one embodiment, is described below.

The operation of the first voltage generation block 100 is described with reference to FIG. 4, and this description is equally applicable to the second and third voltage generation blocks 200 and 300 having the same configuration as the first voltage generation block 100.

The resistance level of the 1-1st voltage level selection unit 110 may vary depending on the tune-on/turn-off of first switch SW1 or the second switch SW2 of the 1-1st voltage level selection unit 110.

The resistance level of the 1-2nd voltage level selection unit 120 may vary depending on the turn-on/turn-off of the third switch SW3 or the fourth switch SW4 of the 1-2nd voltage level selection unit 120.

The 1-1st voltage level selection unit 110, the first division voltage generation unit 130, and the 1-2nd voltage level selection unit 120 may be connected in series between the voltage supply node V_supply and the ground voltage node VSS, and the resistance level of the first division voltage generation unit 130 may be fixed.

Therefore, when the resistance level of the 1-1st voltage level selection unit 110 is varied to determine the voltage level of the first node Node_A and the resistance level of the 1-2nd voltage level selection unit 120 is varied to determine the voltage level of the second node Node_B, the first division voltage generation unit 130 may divide the voltages of the first node Node_A and the second node Node_B and output the first division voltage group V_d0<0:7>.

As an example, it is assumed that the voltage level of the to first node Node_A is 5 V, the voltage level of the second node Node_B is 1.5 V, and the voltage level differences of the respective division voltages V_d0<i> of the first division voltage group V_d0<0:7> are equal to one another. In this example, the respective division voltages V_d0<i> of the first division voltage group V_d0<0:7> have the following voltage levels: V_d0<0>=1.5 V, V_d0<1>=2 V, V_d0<2>=2.5 V, V_d0<3>=3 V, V_d0<4>=3.5 V, V_d0<5>=4 V, V_d0<6>=4.5 V, and V_d0<7>=5 V.

Consequently, in the first voltage generation block 100, when the voltage levels of the first and second nodes Node_A and Node_B are determined, the voltage level of the first node Node_A becomes the maximum voltage level of the first division voltage group V_d0<0:7>, and the voltage level of the second node Node_B becomes the minimum voltage level of the first division voltage group V_d0<0:7>. That is, the respective division voltages V_d0<i> of the first division voltage group V_d0<0:7> have voltage levels ranging from the voltage level of the first node Node_A to the voltage level of the second node Node_B.

Likewise, when the voltage levels of the third through sixth nodes Node_C, Node_D, Node_E, and Node_F are determined by the 2-1st and 2-2nd voltage level selection units 210 and 220 and the 3-1st and 3-2nd voltage level selection units 310 and 320, the second and third voltage generation blocks 200 and 300 generate the second and third division voltage groups V_d1<0:7> and V_d2<0:7>, respectively.

When one of the switches SW<0> through SW<7> illustrated in FIG. 5 is turned on, the first switch block 400 may output one division voltage V_d0<i> of the first division voltage group V_d0<0:7> as the first reference voltage Vref1.

Also, the second switch block 500 may output one division voltage V_d1<j> of the second division voltage group V_d1<0:7> as the second reference voltage Vref2. Also, the third switch block 600 may output one division voltage V_d2<k> of the third division voltage group V_d2<0:7> as the third reference voltage Vref3.

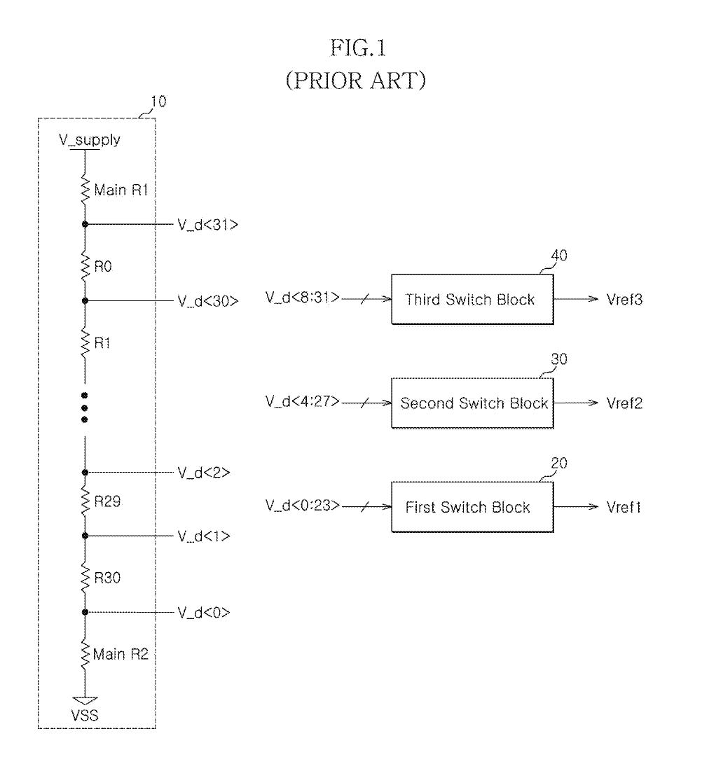

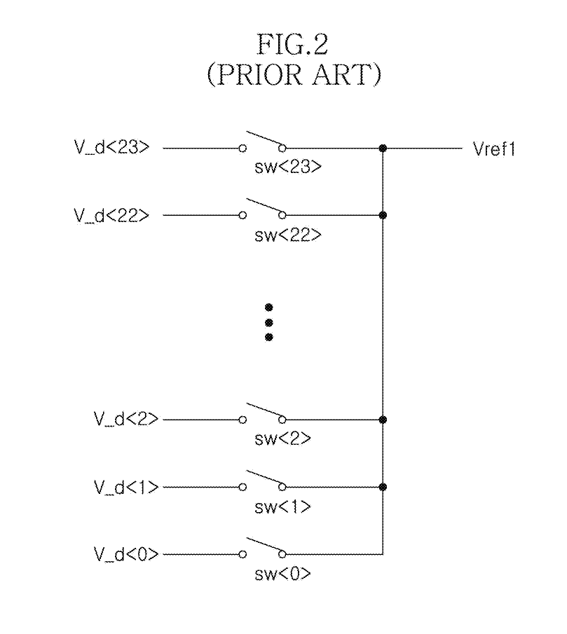

The conventional voltage trimming circuit illustrated in FIGS. 1 and 2 may be configured to trim the first through third reference voltages Vref1 through Vref3 into twenty-four levels. The set of the respective twenty-four division voltages V_d<0:23>, V_d<4:27>, and V_d<8:31> may be inputted to the first through third switch blocks 20 through 40. Therefore, the respective switch blocks 20 through 40 may require twenty-four lines for transferring the respective twenty-four division voltages V_d<0:23>, V_d<4:27>, and V_d<8:31>, that is, a total of seventy-two lines. Also, since each of the switch blocks 20 through 40 may include twenty-four switches, a total of seventy-two switches may be required.

However, the voltage trimming circuit illustrated in FIGS. 3 through 5, according to one embodiment, may trim the first through third reference voltages Vref1 through Vref3 into thirty-two levels. The first through third division voltage groups V_d0<0:7>, V_d1<0:7>, and V_d2<0:7>, each including eight division voltages, may be inputted to the first through third switch blocks 400 through 600. Therefore, the respective switch blocks 400 through 600 may require eight lines for transferring the respective eight division voltages V_d0<0:7>, V_d1<0:7>, and V_d2<0:7>, that is, a total of twenty-four lines. Also, since each of the switch blocks 400 is through 600 may include eight switches, a total of twenty-four switches may be required.

Therefore, the voltage trimming circuit of the semiconductor memory apparatus according to one embodiment may trim a larger number of voltage levels than the conventional art, improve the area efficiency of the semiconductor memory apparatus, and reduce the fabrication costs of the semiconductor memory apparatus because fewer switches and resistors may be used than in the conventional art.

While certain embodiments have been described above with reference to illustrative examples for particular applications, it will be understood to those skilled in the art that the embodiments described are by way of example only. Those skilled in the art with access to the teachings provided in this disclosure will recognize additional modifications, applications, and/or embodiments and additional fields in which the present disclosure would be of significant utility. Accordingly, the voltage trimming circuit described herein should not be limited based on the described embodiments. Rather, the voltage trimming circuit described herein should only be limited in light of the claims that follow when taken in conjunction with the above description and accompanying drawings.

What is claimed is:

1. A voltage trimming circuit of a semiconductor memory apparatus, comprising:
a first voltage generation block configured to select voltage levels of a first node and a second node and divide a voltage between the first node and the second node to generate a first division voltage group;
a second voltage generation block configured to select voltage levels of a third node and a fourth node and divide a voltage between the third node and the fourth node to generate a second division voltage group, wherein the voltage levels of the third node and the fourth node are different from the voltage levels of the first node and the second node, respectively;
a first switch block configured to select one division voltage of the first division voltage group to output the selected division voltage as a first reference voltage; and
a second switch block configured to select one division voltage of the second division voltage group to output the selected division voltage as a second reference voltage.

2. The voltage trimming circuit according to claim 1, wherein each of the first voltage group and the second division voltage group comprises a plurality of division voltages having different levels.

3. The voltage trimming circuit according to claim 1, wherein each of the first voltage generation block and the second voltage generation block comprises a first voltage level selection unit, a division voltage generation unit, and a second voltage level selection unit, and wherein the first voltage level selection unit, the division voltage generation unit, and the second voltage level selection unit are connected in series between a voltage supply node and a ground voltage node.

4. The voltage trimming circuit according to claim 3, wherein the first voltage level selection unit of the first voltage generation block is configured to select the voltage level of the first node.

5. The voltage trimming circuit according to claim 4, wherein the first voltage level selection unit comprises:
a plurality of resistors connected in series between the voltage supply node and the first node; and
a plurality of switches connected to both terminals of the plurality of respective resistors.

6. The voltage trimming circuit according to claim 3, wherein the division voltage generation unit of the first voltage generation block comprises a plurality of resistors connected in series between the first node and the second node, and is configured to generate respective division voltages through nodes where the resistors are connected and output the division voltages as the first division voltage group.

7. The voltage trimming circuit according to claim 6, wherein the first switch block comprises a plurality of switches, wherein the division voltages are inputted to respective input terminals of the plurality of switches, and wherein the first reference voltage is outputted through a node where output terminals of the plurality of switches are connected.

8. The voltage trimming circuit according to claim 3, wherein the second voltage level selection unit of the first division group generation block is configured to select the voltage level of the second node.

9. The voltage trimming circuit according to claim 8, wherein the second voltage level selection unit comprises:
a plurality of resistors connected in series between the ground voltage node and the second node; and
a plurality of switches connected to both terminals of the plurality of respective resistors.

10. The voltage trimming circuit according to claim 3, wherein the first voltage level selection unit of the second voltage generation block is configured to select the voltage level of the third node.

11. The voltage trimming circuit according to claim 10, wherein the first voltage level selection unit comprises:
a plurality of resistors connected in series between the voltage supply node and the third node; and
a plurality of switches connected to both terminals of the plurality of resistors.

12. The voltage trimming circuit according to claim 3, wherein the division voltage generation unit of the second voltage generation block comprises a plurality of resistors connected in series between the third node and the fourth node, and is configured to generate respective division voltages through nodes where the resistors are connected and output the division voltages as the second division voltage group.

13. The voltage trimming circuit according to claim 3, wherein the second voltage level selection unit of the second voltage generation block is configured to select the voltage level of the fourth node.

14. The voltage trimming circuit according to claim 13, wherein the second voltage level selection unit comprises:
a plurality of resistors connected in series between the ground voltage terminal and the fourth node; and
a plurality of switches connected to both terminals of the plurality of respective resistors.

15. The voltage trimming circuit according to claim 14, wherein the second switch block comprises a plurality of switches, wherein the respective division voltages are inputted to input terminals of the plurality of switches, and wherein the second reference voltage is outputted through a node where output terminals of the switches are connected.

16. A voltage trimming circuit of a semiconductor memory apparatus, comprising:
a first voltage generation block configured to divide a supply voltage, generate a first division voltage group, and select a maximum voltage level and a minimum voltage level of the first division voltage group;
a second voltage generation block configured to divide the supply voltage, generate a second division voltage group, and select a maximum voltage level and a minimum voltage level of the second division voltage group;
a first switch block configured to select one division voltage of the first division voltage group to output the selected division voltage as a first reference voltage; and
a second switch block configured to select one division voltage of the second division voltage group to output the selected division voltage as a second reference voltage.

17. The voltage trimming circuit according to claim 16, wherein each of the first division voltage group and the second division voltage group comprises a plurality of division voltages having different levels.

18. The voltage trimming circuit according to claim 17, wherein each of the first voltage generation block and the second voltage generation block comprises a plurality of resistors connected in series between a first node and a second node and is configured to output the division voltages through terminals of the respective resistors.

19. The voltage trimming circuit according to claim 18, wherein each of the first second division voltage generation block and the second division voltage generation blocks comprises:
a first voltage level selection unit configured to select a voltage level of the first node; and
a second voltage level selection unit configured to select a voltage level of the second node.
